(19) United States
(12) Patent Application Publication
(10) Pub. No.: US 2026/0299990 A1
(43) Pub. Date: Oct. 1, 2026

(54) DYNAMIC STOPPING OF VIRTUAL MACHINE’S VIRTUAL CPUS FOR INSTRUMENTATION POINTS

(71) Applicant: Palo Alto Networks, Inc., Santa Clara, CA (US)

(72) Inventor: Matthew Steven Leinhos, Fishers, IN (US)

(21) Appl. No.: 19/097,557

(22) Filed: Apr. 1, 2025

(51) Int. Cl. G06F 9/455

(52) U.S. Cl. CPC G06F 9/45558; G06F 2009/45575; G06F 2009/45591

(57) ABSTRACT

A virtual machine is instantiated. Execution of a virtual CPU associated with the virtual machine is monitored. It is determined, based on metadata associated with a breakpoint, whether the execution of the virtual CPU should be stopped. In response to determining that the execution of the virtual CPU should not be stopped, the execution of the virtual CPU is resumed.

### BACKGROUND OF THE INVENTION

Virtual Machine Introspection (VMI) is a technique that allows an external entity, such as a hypervisor, to monitor and analyze the internal state of a virtual machine (VM) without interfering with its normal operations. A VMI framework may include deploying instrumentation points, also referred to as breakpoints, to a guest's virtual CPU (vCPU) to monitor and capture specific events. When the guest process reaches an instrumentation point, the vCPU is typically stopped to preserve the virtual machine's state. This behavior ensures a consistent snapshot of the system, which can be helpful for further analysis, but it introduces performance overhead due to vCPU rundown and lost clock cycles.

### BRIEF DESCRIPTION OF THE DRAWINGS

Various embodiments of the invention are disclosed in the following detailed description and the accompanying drawings.

FIG. 1 is a block diagram illustrating a system to dynamically stop a virtual machine's virtual CPUs (vCPUs) for instrumentation points in accordance with some embodiments.

FIG. 2 is a flow diagram illustrating a process to dynamically stop a virtual machine's vCPUs for instrumentation points in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Systems and methods of dynamically stopping a virtual machine's virtual CPUs (vCPUs) for instrumentation points are disclosed herein. When performing virtual machine introspection (VMI), a user of a hypervisor may use instrumentation points, also referred to as breakpoints, to monitor and capture specific events in a program executing in a guest operating system of a virtual machine. Through an introspection module on the hypervisor, the user may further indicate, using the breakpoint's metadata, whether reaching the breakpoint should cause the virtual machine to stop executing the program.

In many cases (e.g., monitoring entry points like page fault handling), stopping the virtual machine at every breakpoint uses unnecessary performance overhead. By indicating that the virtual machine should be resumed in these cases, necessary information about the event can be gathered without interrupting execution. In other cases, indicating that the virtual machine should be stopped allows the hypervisor to capture a consistent snapshot of the program execution. In both scenarios, information about the event is published to the user of the hypervisor for further introspection.

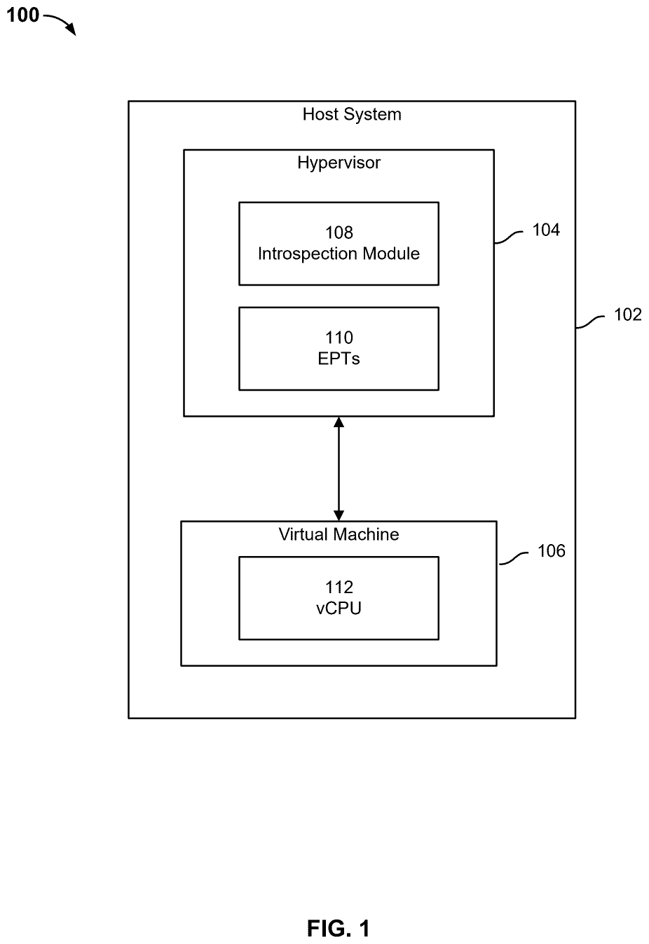

FIG. 1 is a block diagram illustrating a system to dynamically stop a virtual machine's vCPUs for instrumentation points in accordance with some embodiments. In the example shown, system 100 includes a host system 102. Host system 102 is a physical server, bare-metal server, workstation, etc., on which hypervisor 104 runs. Hypervisor 104 is software that creates and manages virtual machines (e.g., virtual machine 106) on host system 102. In some embodiments, hypervisor 104 is configured to instantiate virtual machine 106. In some embodiments, hypervisor 104 runs directly on the physical hardware of host system 102, without the need for an underlying operating system. In some embodiments, hypervisor 104 runs on top of an operating system associated with host system 102. The host operating system is responsible for managing the hardware and the hypervisor runs as an application within the host operating system.

Hypervisor 104 may perform VMI by communicating with virtual machine 106 through introspection module 108. In some embodiments, introspection module 108 communicates with virtual machine 106 via an application programming interface (API). Virtual machine 106 includes one or more vCPUs such as vCPU 112.

Hypervisor 104 further includes extended page tables (EPTs) 110. The EPT mechanism is a feature that can be used to support the virtualization of physical memory. When EPT is in use, certain addresses that would normally be treated as physical addresses (and used to access memory) are instead treated as guest-physical addresses. Guest-physical addresses are translated by traversing a set of EPT paging structures to produce physical addresses that are used to access memory. Each physical page mapped in EPT can have three explicit permissions: read, write, and execute.

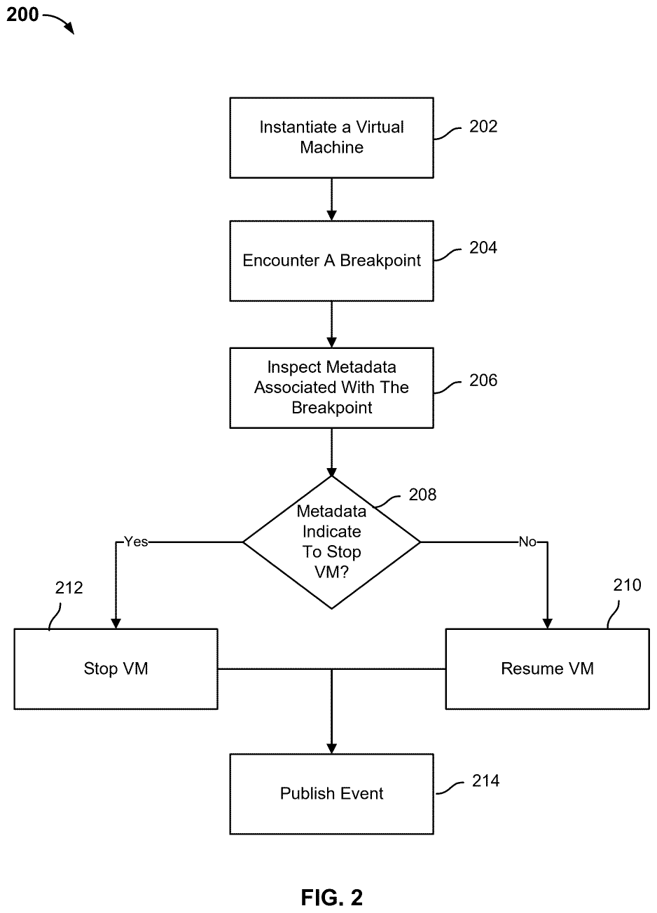

FIG. 2 is a flow diagram illustrating a process to dynamically stop a virtual machine's virtual CPUs (vCPUs) for instrumentation points in accordance with some embodiments. Process 200 may be performed by a hypervisor, such as hypervisor 104, which includes an introspection module, such as introspection module 108, and EPTs, such as EPTs 110.

At 202, a virtual machine is instantiated. Instantiating the virtual machine may include allocating system resources such as one or more vCPUs and memory from a host system, such as host system 102.

At 204, a breakpoint is encountered. The breakpoint is a user-defined instrumentation point deployed by the hypervisor to monitor a specific event in the execution of a process on the virtual machine. The breakpoint is deployed through the introspection module. In some embodiments, the breakpoint is one that stops the virtual machine. In some embodiments, the breakpoint is one that does not stop the virtual machine. The breakpoint may be a read breakpoint, a write breakpoint, and/or an execute breakpoint.

At 206, metadata associated with the breakpoint is inspected. In some embodiments, the breakpoint metadata (maintained in user mode) includes the control structure which contains the data passed in through an introspection module such as introspection module 108 or some other application programming interface associated with a hypervisor such as hypervisor 104 (which includes the CR3 of the breakpoint, the guest linear address—including which accesses to break on, whether to stop the virtual machine or vCPU or neither, whether to force a page copy, whether a guest kernel access should cause a violation event, whether other guest user contexts should cause a violation event, and/or any arbitrary user data to be passed back to the user when this breakpoint is hit).

The breakpoint metadata may further include any of the following: the guest physical address of the breakpoint, whether the breakpoint uses halts and whether the halts have been installed into the page, the original bytes, the associated page and EPT view data structures, an array of counters to track pending virtual machine resumes, an array of counters to track pending vCPU resumes, and a reference count to track the breakpoint usage count across the system.

At 208, it is determined whether the metadata indicates to stop the virtual machine. The introspection module may decide whether the breakpoint should stop the virtual machine and provide that information in the metadata. For example, a user may deploy two breakpoints to detect and analyze execution at a page fault event: one on entry to a page fault handler and another at one of a plurality of exit points from the page fault handler. The introspection module may determine that the first breakpoint metadata should indicate not stopping the virtual machine. The introspection module may further determine that the second breakpoint's metadata should indicate stopping the virtual machine, allowing for further analysis once the page fault handler has exited and completed execution.

In another scenario, a user may deploy read/write breakpoints on a page only to monitor and log access attempts. In this example, the introspection module may determine that the breakpoint metadata should indicate that the virtual machine does not stop upon hitting the breakpoint.

In response to a determination that the metadata indicates not stopping the virtual machine, process 200 proceeds to 210.

In response to a determination that the metadata indicates stopping the virtual machine, process 200 proceeds to 212.

At 210, the virtual machine is resumed. In some embodiments, metadata about the event (e.g., the address in memory where a page fault was detected, or the guest access attempt), is collected asynchronously while the virtual machine is resumed. This approach optimizes performance by avoiding unnecessary virtual stops while still capturing the relevant access attempts for analysis.

In the first example, the additional performance overhead involved in stopping the virtual machine is avoided by resuming execution when the page fault handler entry breakpoint is hit because publishing the necessary information about the event does not require putting the virtual machine in a stopped state. Similarly, in the second example, when the guest software attempts to access the monitored page, the hypervisor can intercept the memory access and log the event to a user-mode component asynchronously while allowing the virtual machine to continue execution without delay.

At 212, the virtual machine is stopped. In some embodiments, stopping the virtual machine includes exiting to user mode. Upon exiting to user mode, any or all metadata included with the breakpoint may be maintained.

At 214, the event is published. In some embodiments, the published event may be added to an event consumer thread for custom analysis. In some embodiments, the event consumer doing the custom analysis is a monitoring tool operated by a system administrator. Publishing the event may include any or all information included in the metadata associated with the breakpoint for further analysis.

This approach ensures that the virtual machine is interrupted on a breakpoint only when indicated by the user of the hypervisor, thereby maintaining performance while allowing for events of interest to be captured and logged.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
instantiating a virtual machine;
monitoring execution of a virtual CPU associated with the virtual machine;
determining, based on metadata associated with a breakpoint, whether the execution of the virtual CPU should be stopped; and
in response to determining that the execution of the virtual CPU should not be stopped, resuming the execution of the virtual CPU.

2. The method of claim 1, further comprising:
determining, based on metadata associated with a second breakpoint, whether the execution of the virtual CPU should be stopped; and
in response to determining that the execution of the virtual CPU should be stopped, stopping the execution of the virtual CPU.

3. The method of claim 2, wherein the second breakpoint is located at one of a plurality of points of exit from the page fault handler.

4. The method of claim 1, wherein the breakpoint is located at the point of entry to a page fault handler.

5. The method of claim 1, wherein the breakpoint is located at a point on a page that indicates an attempted read/write access.

6. The method of claim 1, wherein the virtual machine is instantiated by a hypervisor.

7. The method of claim 6, wherein the hypervisor uses extended page tables to translate physical addresses associated with the memory of a host system to guest-physical addresses associated with the virtual machine memory.

8. The method of claim 6, wherein the hypervisor communicates with the virtual machine through an introspection module.

9. The method of claim 8, wherein the introspection module communicates with the virtual machine via an application programming interface.

10. The method of claim 8, wherein the breakpoint is deployed by the introspection module.

11. The method of claim 8, wherein the metadata associated with the breakpoint is configured by the introspection module.

12. The method of claim 1, further comprising:
encountering the breakpoint; and
inspecting the metadata associated with the breakpoint.

13. The method of claim 1, further comprising publishing an event based on the execution of a process at the breakpoint.

14. The method of claim 13, wherein publishing the event includes publishing information included in the metadata associated with the breakpoint.

15. The method of claim 1, wherein instantiating the virtual machine includes instantiating one or more virtual CPUs.

16. A system, comprising:
a processor configured to:
instantiate a virtual machine;
monitor execution of a virtual CPU associated with the virtual machine;
determine, based on metadata associated with a breakpoint, whether the execution of the virtual CPU should be stopped;
in response to determining that the execution of the virtual CPU should not be stopped, resume execution of the virtual CPU; and
a memory coupled to the processor and configured to provide the processor with instructions.

17. The system of claim 16, further comprising:
determine, based on metadata associated with a second breakpoint, whether the execution of the virtual CPU should be stopped; and
in response to determining that the execution of the virtual CPU should be stopped, stop the execution of the virtual CPU.

18. The system of claim 16, wherein the virtual machine is instantiated by a hypervisor.

19. The system of claim 18, wherein the hypervisor uses extended page tables to translate physical addresses associated with the memory of a host system to guest-physical addresses associated with the virtual machine memory.

20. A computer program product embodied in a non-transitory computer readable medium and comprising computer instructions for:
instantiating a virtual machine;
monitoring execution of a virtual CPU associated with the virtual machine;
determining, based on metadata associated with a breakpoint, whether the execution of the virtual CPU should be stopped; and
in response to determining that the execution of the virtual CPU should not be stopped, resuming the execution of the virtual CPU.
